(19) United States
(12) Patent Application Publication
(10) Pub. No.: US 2014/0239568 A1
(43) Pub. Date: Aug. 28, 2014

(54) ROTARY TABLE FOR MACHINE TOOL

(71) Applicant: FANUC Corporation, Yamanashi (JP)

(72) Inventor: Michi MASUYA, Yamanashi (JP)

(73) Assignee: FANUC Corporation, Yamanashi (JP)

(21) Appl. No.: 14/181,924

(22) Filed: Feb. 17, 2014

(30) Foreign Application Priority Data
Feb. 25, 2013 (JP) 2013-001009

(51) Int. Cl. B23Q 1/26

(52) U.S. Cl. CPC B23Q 1/26
USPC 269/57

(57) ABSTRACT

A rotation drive device that rotates a jig plate on which a workpiece is set and a rotating shaft supporting device that supports the jig plate are disposed such as to oppose each other with the jig plate interposed therebetween. The rotation drive device and the rotating shaft supporting device are placed on a base plate. A spacer is inserted between the rotation drive device or the rotating shaft supporting device and the base plate, thereby making equal a center height of a rotating axis of the rotation drive device and a center height of a rotating axis of the rotating shaft supporting device.

### BACKGROUND OF THE INVENTION

1. Field of the Invention

The present invention relates to a rotary table for a machine tool.

2. Description of the Related Art

As rotary tables used in machine tools, there is a rotary table that uses a rotation drive device singly (see FIG. 3), and a so-called “cradle-type” rotary table in which a jig plate is rotated by a rotation drive device and a rotating shaft supporting device. The rotary table illustrated in FIG. 3 includes a first rotation drive device 10 that includes a position detecting device 11. The rotary table is manufactured such that the height (center height) of a rotating shaft 12 thereof from an installation surface is 5a. The rotary table is fixed to a table 33 of the machine tool by bolts 13.

The cradle-type rotary table includes a jig plate on which a workpiece is set, a rotation drive device that rotates the jig plate, a rotating shaft supporting device that is provided in a position opposing the rotation drive device and supports the jig plate, and a base plate on which both the rotation drive device and the rotating shaft supporting device are placed.

In the cradle-type rotary table, the height (center height) of the shaft from the installation surface on the rotation drive device side and the height (center height) of the shaft from the installation surface on the rotating shaft supporting device side are required to be matched. To match the heights, a case on the rotation drive device side and a case on the rotating shaft supporting device side are required to be machined with high accuracy. This machining involves numerous steps.

As the rotation drive device of cradle-type rotary table, a rotary table rotation drive device that is used singly is often used. In the cradle-type rotary table, the center height of the rotation drive device is required to be matched with the center height of the rotating shaft supporting device, as described above. To match the center heights, although preparing a rotation drive device that has the same center height as the center height of the rotating shaft supporting device is preferable, it is generally difficult to prepare a rotation drive device that has the same center height as the center height of the rotating shaft supporting device. Special machining for matching the center height of the rotation drive device with the center height of the rotating shaft supporting device is required. In consequence, a rotation drive device to be used singly cannot be directly used as a rotation drive device of cradle-type rotary table.

### SUMMARY OF THE INVENTION

With that, in view of the above-described problems in the prior art techniques, it is an object of the present invention to provide a rotary table for a machine tool in which a center height on a rotation drive device side or a center height on a rotating shaft supporting device side of a cradle-type rotary table can be adjusted using a spacer, and that is capable of achieving commonality between a rotation drive device to be used singly and a rotation drive device of cradle-type rotary table.

A first mode of the rotary table for a machine tool according to the present invention includes a jig plate on which a workpiece is set, a rotation drive device that rotates the jig plate, a rotating shaft supporting device that is provided in a position opposing the rotation drive device and supports the jig plate, and a base plate on which the rotation drive device and the rotating shaft supporting device are placed. A spacer is inserted between the rotation drive device or the rotating shaft supporting device and the base plate.

A second mode of the rotary table for a machine tool according to the present invention includes a jig plate on which a workpiece is set, first and second rotation drive devices that are disposed such as to oppose each other on left and right sides of the jig plate and that synchronously rotate the jig plate, and a base plate on which the first and second rotation drive devices are placed. A spacer is inserted between the first rotation drive device or the second rotation drive device and the base plate.

According to the present invention, a rotary table for a machine tool can be provided in which a center height on a rotation drive device side or a center height on a rotating shaft supporting device side of a cradle-type rotary table can be adjusted using a spacer, and that is capable of achieving commonality between a rotation drive device to be used singly and a rotation drive device of cradle-type rotary table.

### BRIEF DESCRIPTION OF THE DRAWINGS

FIG. 1 is a diagram that illustrates a first embodiment of a rotary table for a machine tool according to the present invention;

FIG. 2 is a diagram that illustrates a second embodiment of a rotary table for a machine tool according to the present invention; and

FIG. 3 is a diagram that illustrates a prior art example of a rotary table for a machine tool that uses a rotation drive device singly.

### DETAILED DESCRIPTION OF THE PREFERRED EMBODIMENTS

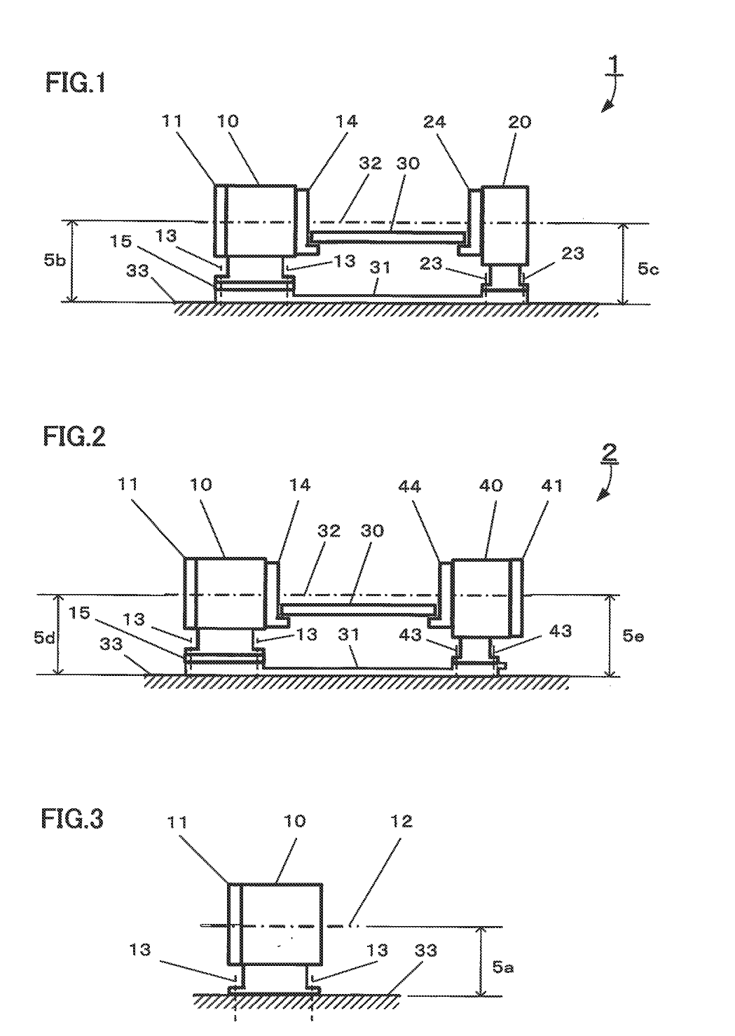

First, a first embodiment of a rotary table for a machine tool according to the present invention will be described with reference to FIG. 1. The rotary table illustrated in FIG. 1 is a cradle-type rotary table.

A cradle-type rotary table 1 includes a jig plate 30 on which a workpiece (not shown) is set, a rotation drive device 10 that rotates the jig plate 30, a rotating shaft supporting device 20 that is provided in a position opposing the rotation drive device 10 and supports the jig plate 30, and a base plate 31 on which the rotation drive device 10 and the rotating shaft supporting device 20 are placed. A position detecting device 11 that detects a rotation position of the rotation drive device 10 is attached to the rotation drive device 10. A first bracket 14 is attached to a rotating axis of the rotation drive device 10. A second bracket 24 is attached to a rotating axis of the rotating shaft supporting device 20. One end of the jig plate 30 is supported by the first bracket 14, and the other end is supported by the second bracket 24.

A plate-shaped spacer 15 is inserted between the rotation drive device 10 and the base plate 31. The rotation drive device 10 is fixed to the base plate 31 by bolts 13 in a manner such that the spacer 15 is sandwiched between the rotation drive device 10 and the base plate 31. The rotating shaft supporting device 20 is fixed to the base plate 31 by bolts 23. The base plate 31 is fixed to a table 33 of the machine tool by bolts (not shown).

A center height 5b of the rotating axis of the rotation drive device 10 is adjusted using the spacer 15. Therefore, the center height 5b of the rotating axis of the rotation drive device 10 and a center height 5c of the rotating axis of the rotating shaft supporting device 20 can be made equal. As a result, the jig plate 30 can be rotated around a common axis 32 on which the rotating axis of the rotation drive device 10 and the rotating axis of the rotating shaft supporting device 20 are aligned. Instead of the plate-shaped spacer 15 being inserted between the rotation drive device 10 and the base plate 31 as shown in FIG. 1, the plate-shaped spacer 15 may be inserted between the rotating shaft supporting device 20 and the base plate 31.

According to the first embodiment, the center height on the rotation drive device side or the center height on the rotating shaft supporting device side of cradle-type rotary table can be adjusted by the spacer. Commonality can be achieved between the rotation drive device to be used singly and the rotation drive device of cradle-type rotary table.

Next, a second embodiment of the rotary table for a machine tool according to the present invention will be described with reference to FIG. 2. The rotary table illustrated in FIG. 2 is a cradle-type rotary table.

A cradle-type rotary table 2 includes the jig plate 30 on which a workpiece (not shown) is set, first and second rotation drive devices 10 and 40 that are disposed such as to oppose each other on left and right sides of the jig plate 30 and that synchronously rotate the jig plate 30, and the base plate 31 on which the first and second rotation drive devices 10 and 40 are placed.

The position detecting device 11 that detects the rotation position of the first rotation drive device 10 is attached to the first rotation drive device 10. The first bracket 14 is attached to the rotating axis of the first rotation drive device 10. A second bracket 44 is attached to a rotating axis of the second rotation drive device 40. One end of the jig plate 30 is supported by the first bracket 14, and the other end is supported by the second bracket 44.

The plate-shaped spacer 15 is inserted between the first rotation drive device 10 and the base plate 31. The first rotation drive device 10 is fixed to the base plate 31 by the bolts 13 in a manner such that the spacer 15 is sandwiched between the first rotation drive device 10 and the base plate 31. The second rotation drive device 40 is fixed to the base plate 31 by bolts 43. The base plate 31 is fixed to the table 33 of the machine tool by bolts (not shown).

A center height 5d of the rotating axis of the first rotation drive device 10 is adjusted using the spacer 15. Therefore, the center height 5d of the rotating axis of the first rotation drive device 10 and a center height 5e of the rotating axis of the second rotation drive device 40 can be made equal. As a result, the jig plate 30 can be rotated around a common axis 32 on which the rotating axis of the first rotation drive device 10 and the rotating axis of the second rotation drive device 40 are aligned. Instead of the plate-shaped spacer 15 being inserted between the first rotation drive device 10 and the base plate 31 as shown in FIG. 2, the plate-shaped spacer 15 may be inserted between the second rotation drive device 40 and the base plate 31.

As a result of the present invention, the center heights of two differing rotation drive devices of cradle-type rotary table can be adjusted by a spacer, and commonality can be achieved in the use of the differing rotation drive devices as the rotation drive devices of cradle-type rotary table.

1. A rotary table for a machine tool, comprising:
a jig plate on which a workpiece is set;
a rotation drive device that rotates the jig plate;
a rotating shaft supporting device that is provided in a position opposing the rotation drive device and supports the jig plate; and
a base plate on which the rotation drive device and the rotating shaft supporting device are placed, wherein
a spacer is inserted between the rotation drive device or the rotating shaft supporting device and the base plate.

2. A rotary table for a machine tool, comprising:
a jig plate on which a workpiece is set;
first and second rotation drive devices that are disposed such as to oppose each other on left and right sides of the jig plate, and that synchronously rotate the jig plate; and
a base plate on which the first and second rotation drive devices are placed, wherein
a spacer is inserted between the first rotation drive device or the second rotation drive device and the base plate.
